(19) United States
(12) Patent Application Publication
(10) Pub. No.: US 2019/0110351 A1
(43) Pub. Date: Apr. 11, 2019

(54) SYNCHRONIZING LIGHT BULBS

(71) Applicant: Russell Rossi, Coral Springs, FL (US)

(72) Inventor: Russell Rossi, Coral Springs, FL (US)

(21) Appl. No.: 15/725,859

(22) Filed: Oct. 5, 2017

(51) Int. Cl. H05B 37/02; H05B 33/08; G06F 3/16; H04R 3/12

(52) U.S. Cl. CPC H05B 37/0272; H05B 33/0845; F21K 9/235; G06F 3/165; H04R 3/12; H05B 33/0863

(57) ABSTRACT

A plurality of light bulbs capable of synchronizing with one another and communicating with a remote computer to receive commands. The light bulb includes a base and a bulb made of a transparent or translucent material. A light source is disposed within the bulb and is electrically connected to the base. Each of the light bulbs include a wireless receiver and a wireless transmitter, such as a wireless transceiver. The light bulbs are capable of communicating with a computer and synchronizing with other light bulbs using the wireless transceiver.

### BACKGROUND OF THE INVENTION

The present invention relates to light bulbs and, more particularly, to synchronizing light bulbs with an audio speaker and color-changing features.

An electric light is a device that produces visible light from electric current. It is the most common form of artificial lighting and is essential to modern society, providing interior lighting for buildings and exterior light for evening and nighttime activities. Multiple lights bulb may be used for each room in a home or place of business.

Speaker systems have become smaller and more powerful through the years. Further, speakers are now able to wirelessly connect with a smart device. The wireless connection allows users to remotely control the type of music being played from the speakers, as well as the volume.

As can be seen, there is a need for light bulbs with speakers that synchronize with one another.

### SUMMARY OF THE INVENTION

In one aspect of the present invention, a system for controlling a plurality of light bulbs comprises: a computer comprising a processor, a memory, and a wireless transmitter; and a plurality of light bulbs each comprising: a base; a bulb comprising a translucent or transparent material; a light source disposed within the bulb and electrically connected to the base; a processor; a wireless receiver; and a wireless transmitter, wherein the computer is in communication with at least one of the plurality of light bulbs via the wireless transmitter of the computer and the wireless receiver of the at least one of the plurality of light bulbs, and the plurality of light bulbs are synchronized to communicate with one another via the wireless receivers and the wireless transmitters so that a command sent from the computer to the at least one of the plurality of light bulbs is sent to a remainder of the plurality of light bulbs.

In another aspect of the present invention, a light bulb comprises: a base; a bulb comprising a translucent or transparent material; a light source disposed within the bulb and electrically connected to the base; and a radio frequency chip operable to wirelessly send and receive data, wherein the light bulb is capable of communicating with a computer and synchronizing with other light bulbs via the radio frequency chip.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is a schematic view of an embodiment of the present invention;

FIG. 3 is flowchart of an embodiment of a method of use; and

FIG. 4 is a schematic view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

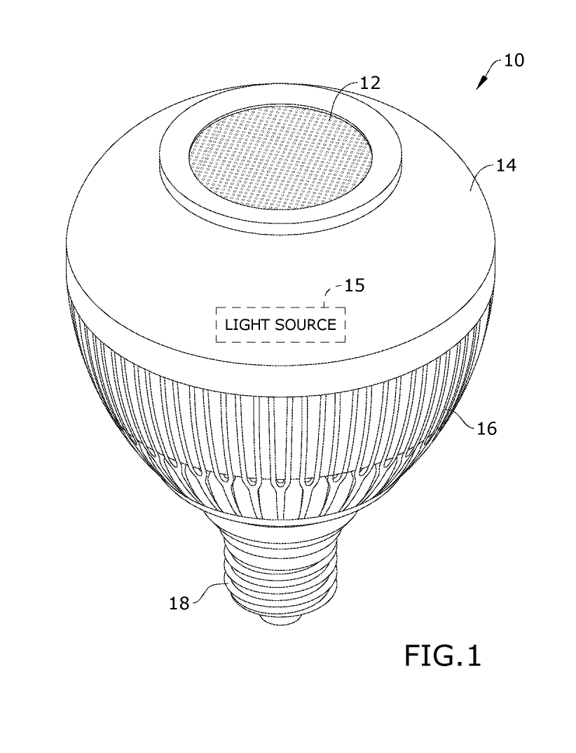

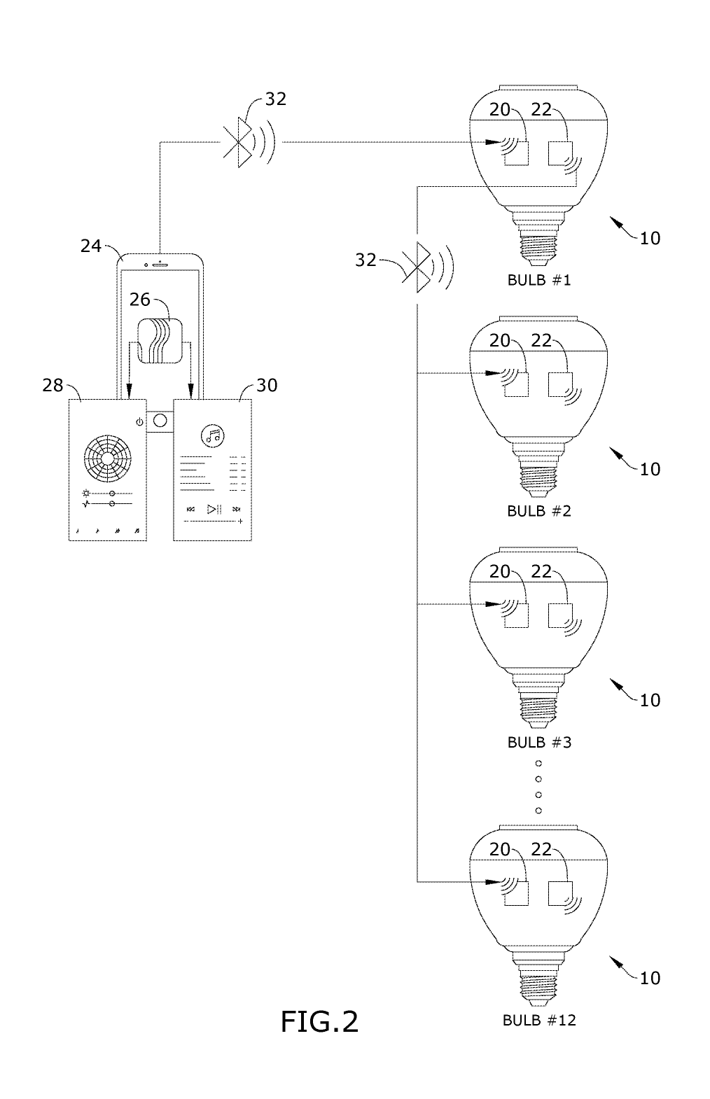

Referring to FIGS. 1 and 2, the present invention includes a plurality of light bulbs 10 capable of synchronizing with one another and communicating with a remote computer 24 to receive commands. The light bulb 10 includes a base 18, such as a threaded base 18 to electrically connect to an electrical socket. The light bulb 10 further includes a bulb 14 made of a transparent or translucent material. A light source 15 is disposed within the bulb 14 and is electrically connected to the base 18. Each of the light bulbs 10 include a wireless receiver 20 and a wireless transmitter 22, such as a wireless transceiver. The light bulbs 10 are capable of communicating with a computer and synchronizing with other light bulbs 10 using the wireless transceiver.

One of the light bulbs 10 first connects to the computer 24 and then broadcasts the connection information immediately to the other light bulbs 10. The light bulb 10 that first connects to the computer 24 assumes the role of the master light bulb 10 and the remained of the light bulbs 10 within the group assume the role of a slave light bulb 10. When the slave light bulbs 10 in the same group receive the connection information from the master bulb 10, the lighting and the sound of the light bulbs 10 are controlled by the computer 24. Thus, the slave light bulbs 10 are consistent with the master light bulb 10, receiving and broadcasting the same information. Thus, no external HUB and/or gateway device is required.

The light bulb 10 of the present invention may further include a speaker 12. In such embodiments, the speaker 12 may be electrically connected to an amplifier which is electrically connected to the base 18. The base 18 may screw into an electrical socket, powering the wireless receiver 20, the wireless transmitter 22, speaker 12 and the light source 15. The speaker 12 may produce any audio provided by the connected computer 24.

In certain embodiments, the light source 15 is a light emitting diode (LED). The LED light source 15 may include a plurality of LED beads and chips. In such embodiments, the LED light bulb 10 may further include a heat sink 16. The light emitting diode may be a multi-colored light emitting diode known as “RGBW” and/or “color-changing.”

The computer 24 may include a desktop, laptop, server, smart device, smart mobile phones, smart tablets and the like. The computer 24 includes a processor, a memory and a user interface. A software 26 is loaded on the memory of the computer 24 to instruct the processor to perform steps.

As illustrated in FIG. 2, the computer 24 may include a smart mobile phone with a touch screen interface. The software may prompt the processor to produce control screens on the touch screen interface. For example, the software may prompt the processor to produce a first control screen 28 that controls the light source 15, color, and lighting presets/functions and a second control screen 30 that controls the speaker 12. In such embodiments, the user's may select commands from the first and second control screens 28, 30 that are in turn sent to the light bulbs 10. The commands may include, but are not limited to: turning the light source 15 on and off; controlling a level of brightness (dimming) of the light source 15; controlling a color of the light source 15; turning the speaker 12 on and off; and controlling a volume of any sound produced by the speaker 12. The user application allows for the light bulbs 10 with speaker 12 to produce audio with the light on or off. Both the light source 15 and speaker 12 functions may work autonomously.

The wireless receiver 20 and transmitter 22 are communications interfaces for communicating with a wireless network. The wireless receiver 20 and transmitter 22 may be chips, such as radio frequency (RF) chips. This disclosure contemplates any suitable network and any suitable communications interface. As an example and not by way of limitation, the light bulbs 10 and computer 24 may communicate with an ad hoc network, a personal area network (PAN), a local area network (LAN), a wide area network (WAN), a metropolitan area network (MAN), or one or more portions of the Internet or a combination of two or more of these. As an example, the light bulbs 10 and computer 24 may communicate with a wireless PAN (WPAN) (e.g., a BLUETOOTH® WPAN 32), a WI-FI network, a WI-MAX network, a cellular telephone network (e.g., a Global System for Mobile Communications (GSM) network), or other suitable wireless network or a combination of two or more of these.

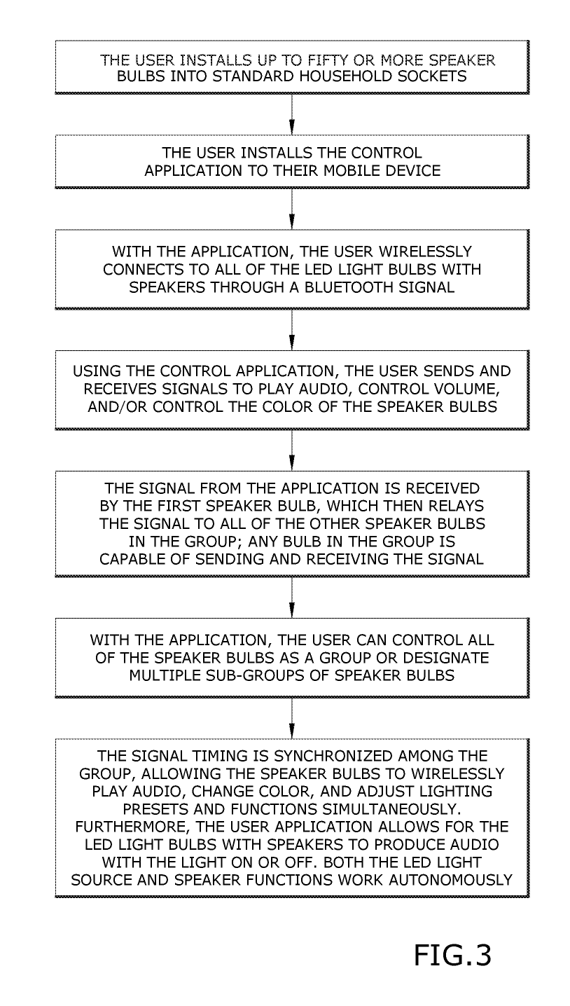

FIG. 3 provides an exemplary flow chart of a method of using the present invention. Speaker bulbs of the present invention include the light bulbs described above with the speaker. The user installs up to fifty or more speaker bulbs into standard electrical sockets. The user installs the control application (software) to their mobile device (smart mobile phone). With the application, the user can control all of the LED light bulbs with speaker as a group or designate multiple sub-groups of speaker bulbs. Using the control application, the user sends signals to play music, control volume, and/or control the color of the speaker bulbs. The signal from the application is received by the first speaker bulb, which then relays the signal to all of the other speaker bulbs in the group. Any bulb in the group is capable of sending and receiving the signal. The signal timing is synchronized among the group, allowing the speaker bulbs to play music, change color etc. simultaneously.

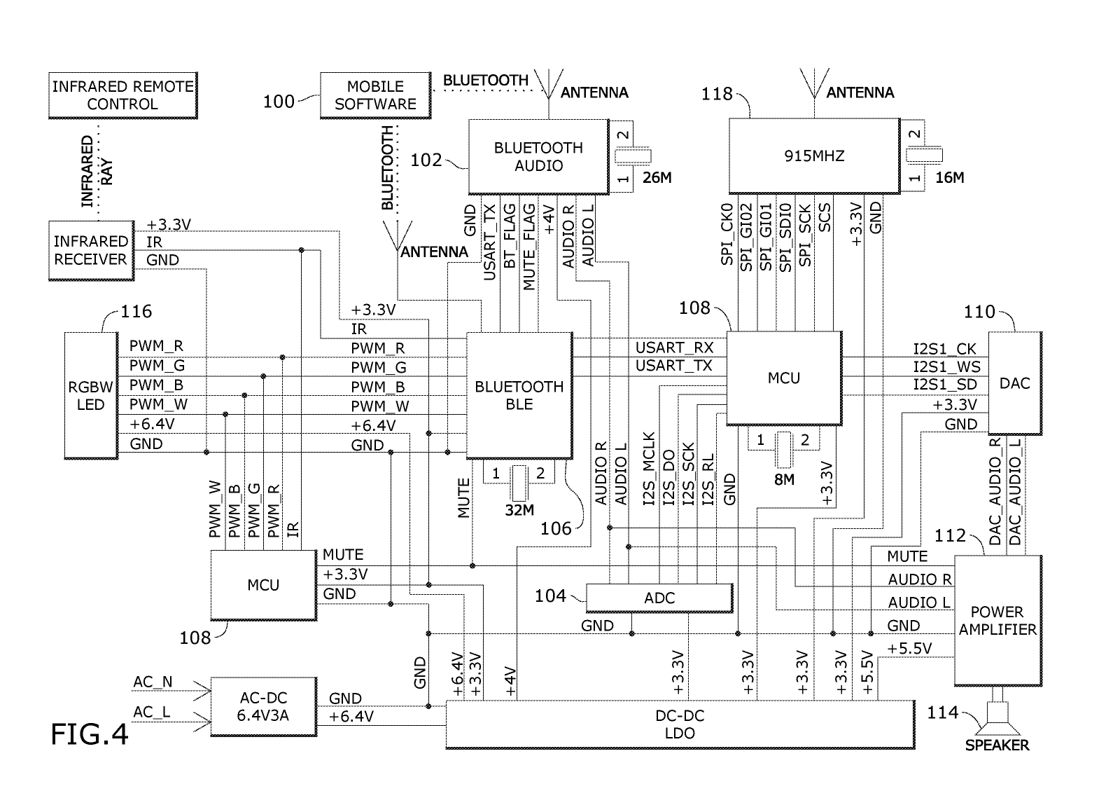

FIG. 4 provides an exemplary schematic view of a computer and a plurality of light bulbs with speakers communicating using BLUETOOTH® technology. Each of the light bulbs may include, a microcontroller (MCU) 108, an analog to digital converter 104 (ADS), a digital to analog converter (DAC) 110 and a radio frequency chip 10 (RF). Any one of the light bulbs can connect with the mobile phone's BLUETOOTH® settings, which is referenced as the master light bulb. All of the other light bulbs receive the broadcast information from the master light bulb, which are referenced as the slave light bulbs. When selected by the user, the computer may send two signals to the master light bulb via the BLUETOOTH® modules 102, 106. The first signal is an audio analog signal which is transmitted by the audio BLUETOOTH® module 102 to the master light bulb. The ADS 104 of the master light bulb converts the audio analog signal to an audio digital signal and transmits the audio digital signal to the MCU 108 of the master light bulb. The second signal is a light digital signal to control the lighting, which is transmitted by the BLUETOOTH® low energy module 106 (BLE) from the computer to the master light bulb. The MCU 108 of the master light bulb transmits the audio digital signal and the light digital signal to the RF 10 of the master light bulb. The RF 10 of the master light bulb broadcasts the audio digital signal and the light digital signal to the slave light bulbs. Each of the RF 10 of the slave modules receive the audio digital signal and the light digital signal from the RF 10 of the master light bulb. The audio digital signal and the light digital signal of each of the slave modules are transmitted to the MCUs 108 of the slave modules. The MCUs 108 transmit the audio digital signal to the DAC 110 to convert the audio digital signal to an audio analog signal. The audio analog signal is then played by the speakers via the amplifier of each of the master and slave light bulbs. The MCUs 108 of the slaves transmit the light digital signal to the BLE 106 module. The BLE module 106 controls the lighting of the master and the slave light bulbs based on the content of the light digital signal. Using the above method, the light bulbs synchronize with one another so that the user may initiate a command that is received and acted upon by each of the light bulbs.

It should be understood, of course, that the foregoing relates to exemplary embodiments of the invention and that modifications may be made without departing from the spirit and scope of the invention as set forth in the following claims.

What is claimed is:

1. A system for controlling a plurality of light bulbs comprising:
a computer comprising a processor, a memory, and a wireless transmitter; and
a plurality of light bulbs each comprising:
a base;
a bulb comprising a translucent or transparent material;
a light source disposed within the bulb and electrically connected to the base;
a wireless receiver; and
a wireless transmitter, wherein
the computer is in communication with one of the light bulbs of the plurality of light bulbs via the wireless transmitter of the computer and the wireless receiver of the at least one of the plurality of light bulbs, and
the plurality of light bulbs are synchronized to communicate with one another via the wireless receivers and the wireless transmitters so that a command sent from the computer to the one of light bulbs of the plurality of light bulbs is sent to a remainder of the plurality of light bulbs.

2. The system of claim 1, wherein the wireless receiver and the wireless transmitter is a radio frequency chip.

3. The system of claim 1, wherein the base is threaded.

4. The system of claim 1, wherein the computer is in communication with the at least one of the plurality of light bulbs and the plurality of light bulbs are synchronized using BLUETOOTH® technology.

5. The system of claim 1, wherein each of the plurality of light bulbs further comprises a speaker electrically connected to the base.

6. The system of claim 5, wherein the command comprises at least one of:
turning the light source on and off; controlling a level of brightness of the light source; turning the speaker on and off; and controlling a volume of a sound produced by the speaker.

7. The system of claim 5, wherein each of the plurality of light bulbs comprise:
a microcontroller;
an analog to digital converter operable to convert an audio analog signal to an audio digital signal, the audio analog signal sent from the computer to the one of the plurality of light bulbs; and
a digital to analog converter operable to convert the audio digital signal to an audio analog signal, the audio digital signal sent from the one of the plurality of light bulbs to the remainder of the plurality of light bulbs.

8. The system of claim 1, wherein the light source is a multi-colored light emitting diode.

9. The system of claim 1, wherein the command comprises at least one of: turning the light source on and off; controlling a level of brightness of the light source; and controlling a color of the light source.

10. A light bulb comprising:
a base;
a bulb comprising a translucent or transparent material;
a light source disposed within the bulb and electrically connected to the base; and
a radio frequency chip operable to wirelessly send and receive data, wherein
the light bulb is capable of communicating with a computer and synchronizing with other light bulbs via the radio frequency chip.

11. The light bulb of claim 10, further comprising:
a microcontroller;
an analog to digital converter operable to convert an audio analog signal to an audio digital signal; and
a digital to analog converter operable to convert the audio digital signal to an audio analog signal.

12. The light bulb of claim 10, wherein the light bulb utilizes BLUETOOTH® technology to communicate with the computer and the other light bulbs.

13. The light bulb of claim 10, wherein the light bulb further comprises a speaker electrically connected to the base.

14. The light bulb of claim 13, wherein the light bulb is configured to receive commands from the computer or from another light bulb wirelessly communicating with the computer, the commands comprising: turning the light source on and off; controlling a level of brightness of the light source; turning the speaker on and off; and controlling a volume of a sound produced by the speaker.

15. The light bulb of claim 10, wherein the light source is a multi-colored light emitting diode.

16. The light bulb of claim 15, wherein the light bulb is configured to receive commands from the computer or from another light bulb wirelessly communicating with the computer, the commands comprising: turning the light source on and off; controlling a level of brightness of the light source; and controlling a color of the light source.
